(19) United States
(12) Patent Application Publication
(10) Pub. No.: US 2015/0071128 A1
(43) Pub. Date: Mar. 12, 2015

(54) MOBILE COMMUNICATION SYSTEM, GATEWAY DEVICE, CHARGING POLICY CONTROL METHOD, AND NON-TRANSITORY COMPUTER READABLE MEDIUM STORING PROGRAM

(71) Applicant: NEC Corporation, Tokyo (JP)

(72) Inventors: Takanori Iwai, Tokyo (JP); Hajime Zembutsu, Tokyo (JP); Hironori Magatani, Tokyo (JP)

(73) Assignee: NEC Corporation, Tokyo (JP)

(21) Appl. No.: 14/397,310

(22) PCT Filed: Apr. 23, 2013
(86) PCT No.: PCT/JP2013/002726

§ 371 Date: Oct. 27, 2014

(30) Foreign Application Priority Data
Apr. 26, 2012 (JP) 2012-101828

(51) Int. Cl. H04L 12/14; H04W 4/24

(52) U.S. Cl. CPC H04L 12/1453; H04L 12/1403; H04W 4/24
USPC 370/259

(57) ABSTRACT

A mobile communication system according to the present invention includes: a node device (50); a service providing server (60); and a gateway device (1) that relays a data communication between these devices. The gateway device (1) includes: a signal reception unit (10) that receives, from the service providing server (60), a charging policy change request signal including identification information about a first communication terminal, and change request information for changing a first charging policy to a second charging policy determined in the service providing server (60); a charging policy extraction unit (20) that identifies, based on the identification information about the first communication terminal, charging policy information about the first communication terminal from a charging server that manages charging policy information about a plurality of communication terminals; and a charging policy control unit (30) that changes the charging policy of the first communication terminal to the second charging policy.

### TECHNICAL FIELD

The present invention relates to a mobile communication system, and more particularly, to a mobile communication system that provides services to communication terminals by using a service providing server.

### BACKGROUND ART

In recent years, various services have been provided to mobile communication terminals such as portable telephone terminals. For example, not only a voice call or e-mail communication between mobile communication terminals, but also services associated with a server device or the like located in an external communication network different from a mobile communication network are provided. In this way, when services have been provided to mobile communication terminals by the server device or the like located in an external communication network, communication charges are charged to the mobile communication terminals based on charging policies determined in the mobile communication network.

Patent Literature 1 discloses a charging control method for changing a charging rule based on a trigger event sent from a UE (User Equipment) or the like, and for applying the changed charging rule. Specifically, Patent Literature 1 discloses that when QoS or the like is changed, a charging rule function unit selects a new charging rule and applies the selected charging rule.

### CITATION LIST

### Patent Literature

Patent Literature 1: Japanese Unexamined Patent Application Publication No. 2010-213302

### SUMMARY OF INVENTION

### Technical Problem

According to the charging control method disclosed in Patent Literature 1, a charging rule defined by a mobile communication carrier or the like is selected, and the selected charging rule is applied to mobile communication terminals and the like. However, it is considered that M2M communications will become widespread in the future and thus there will be more opportunities for mobile communication terminals to be provided with services in cooperation with the server device or the like located in an external communication network. It is also considered that there are a variety of service contents that can be provided in cooperation with the server device or the like located in the external communication network, and there are also a variety of charge forms depending on the services. Accordingly, there is a problem that when only the charging rule defined by the mobile communication carrier is applied to mobile communication terminals, it is difficult to set a flexible charging rule depending on the service contents.

To solve the above-mentioned problem, it is an object of the present invention to provide a mobile communication system, a gateway device, a charging policy control method, and a program, which are capable of setting a flexible charging rule depending on service contents.

### Solution to Problem

A mobile communication system according to a first exemplary aspect of the present invention is a mobile communication system including: a node device located in a mobile communication network; a service providing server located in an external communication network different from the mobile communication network; and a gateway device that relays a data communication between the node device and the service providing server. The gateway device includes: a signal reception unit that receives a charging policy change request signal from the service providing server, the charging policy change request signal including: identification information about a first communication terminal that performs communication via the mobile communication network; and a charging policy change request for requesting to change a first charging policy applied to the first communication terminal to a second charging policy determined in the service providing server; a charging policy extraction unit that identifies, based on the identification information about the first communication terminal, charging policy information about the first communication terminal from a charging server that manages charging policy information about a plurality of communication terminals; and a charging policy control unit that changes a charging policy applied to the first communication terminal from the first charging policy to the second charging policy.

A gateway device according to a second exemplary aspect of the present invention is a gateway device that relays a data communication between a node device located in a mobile communication network and a service providing server located in an external communication network different from the mobile communication network. The gateway device includes: a signal reception unit that receives a charging policy change request signal from the service providing server, the charging policy change request signal including: identification information about a first communication terminal that performs communication via the mobile communication network; and a charging policy change request for requesting to change a first charging policy applied to the first communication terminal to a second charging policy determined in the service providing server; a charging policy extraction unit that identifies, based on the identification information about the first communication terminal, charging policy information about the first communication terminal from a charging server that manages charging policy information about a plurality of communication terminals; and a charging policy control unit that changes a charging policy applied to the first communication terminal from the first charging policy to the second charging policy.

A charging control method according to a third exemplary aspect of the present invention is a charging policy control method in a gateway device that relays a data communication between a node device located in a mobile communication network and a service providing server located in an external communication network different from the mobile communication network. The charging policy control method includes: receiving, from the service providing server, a charging policy change request signal including: identification information about a first communication terminal that performs communication via the mobile communication network; and a charging policy change request for requesting to change a first charging policy applied to the first communication terminal to a second charging policy determined in the service providing server; identifying, based on the identification information about the first communication terminal, charging policy information about the first communication terminal from a charging server that manages charging policy information about a plurality of communication terminals; and changing a charging policy applied to the first communication terminal from the first charging policy to the second charging policy.

A program according to a fourth exemplary aspect of the present invention is a program causing a computer in a gateway device that relays a data communication between a node device located in a mobile communication network and a service providing server located in an external communication network different from the mobile communication network, to execute the steps of: receiving, from the service providing server, a charging policy change request signal including: identification information about a first communication terminal that performs communication via the mobile communication network; and a charging policy change request for requesting to change a first charging policy applied to the first communication terminal to a second charging policy determined in the service providing server; identifying, based on the identification information about the first communication terminal, charging policy information about the first communication terminal from a charging server that manages charging policy information about a plurality of communication terminals; and changing a charging policy applied to the first communication terminal from the first charging policy to the second charging policy.

### Advantageous Effects of Invention

According to the present invention, it is possible to provide a mobile communication system, a gateway device, a charging policy control method, and a program, which are capable of setting a flexible charging rule depending on service contents.

### BRIEF DESCRIPTION OF DRAWINGS

FIG. 1 is a block diagram showing a mobile communication system according to a first exemplary embodiment;

FIG. 2 is a block diagram showing the mobile communication system according to the first exemplary embodiment;

FIG. 3 is a diagram showing an MTC-IWF according to the first exemplary embodiment;

FIG. 4 is a diagram illustrating a flow of a process for transmitting a charging policy change request signal according to the first exemplary embodiment;

FIG. 5 is a diagram illustrating a flow of a charging policy change control process according to the first exemplary embodiment;

FIG. 6 is a diagram illustrating a flow of a charging policy change control process according to a second exemplary embodiment; and

FIG. 7 is a block diagram showing a case where an MTC-IWF according to the second exemplary embodiment is applied to a network specified in 3GPP technical specifications.

### DESCRIPTION OF EMBODIMENTS

### First Exemplary Embodiment

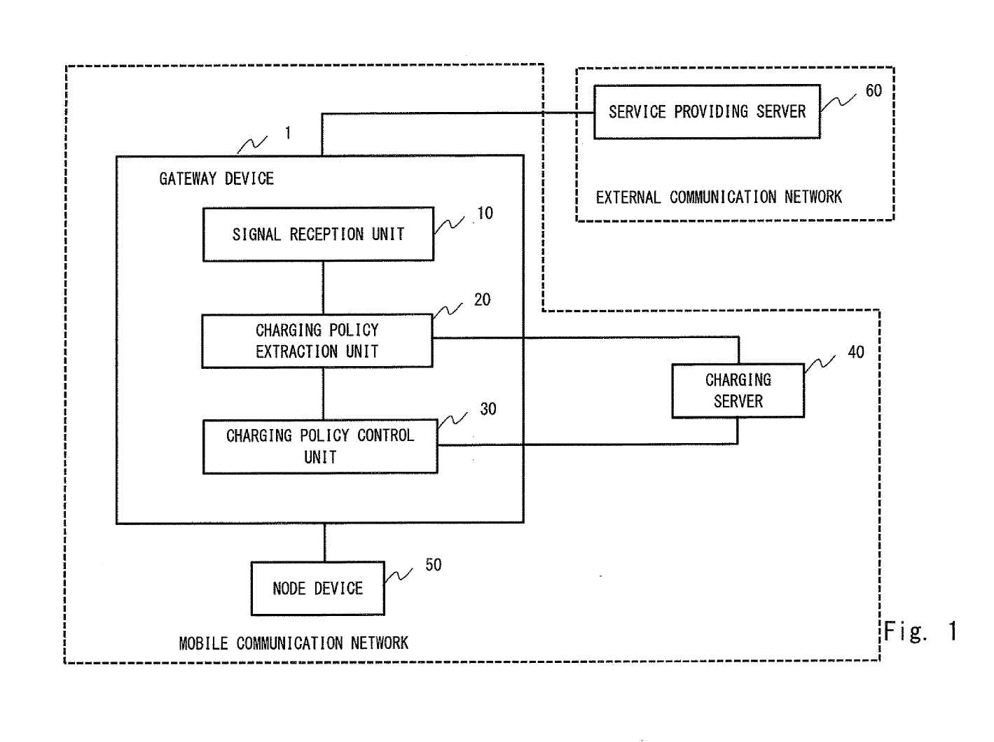

Exemplary embodiments of the present invention will be described below with reference to the drawings. Referring first to FIG. 1, a configuration example of a gateway device according to a first exemplary embodiment of the present invention and a configuration example of a mobile communication system including peripheral devices of the gateway device will be described.

The mobile communication system includes a gateway device 1, a charging server 40, a node device 50, and a service providing server 60. The gateway device 1 includes a signal reception unit 10, a charging policy extraction unit 20, and a charging policy control unit 30. The gateway device 1, the charging server 40, and the node device 50 are located in a mobile communication network, and the service providing server 60 is located in an external communication network.

The gateway device 1 relays a data communication between the node device 50 and the service providing server 60. The components of the gateway device 1 will be described below.

The signal reception unit 10 receives a charging policy change request signal from the service providing server 60. The charging policy change request signal includes identification information about a communication terminal, and a charging policy change request for requesting to change a charging policy applied to the communication terminal to a charging policy determined in the service providing server 60.

The communication terminal is a terminal that communicates with another communication terminal, a server device, or the like via the mobile communication network. Specifically, the communication terminal is a terminal that is used by a user who subscribes to a mobile communication carrier that manages the mobile communication network. Examples of the identification information about the communication terminal may include a MAC address, an IP address, and a telephone number, which are allocated to the communication terminal, and also include the machine number of the communication terminal.

The term “charging policy” refers to a charging rule that defines a person who is to be charged, a charge rate, and the like. The person who is to be charged is a person who pays communication charges incurred by data communication. The person who is to be charged may be, for example, a person who owns the communication terminal, or a person who manages the service providing server 60. The charge rate may be determined depending on, for example, a period of time in which a bearer that is set for the communication terminal to establish a communication is maintained, or the amount of data communication by the communication terminal.

The charging policy defined by the mobile communication carrier that manages the mobile communication network is generally applied to the communication terminal. In this case, the service providing server 60 transmits the charging policy change request signal to the gateway device 1 so that the charging policy determined by the mobile communication carrier is changed to a charging policy determined by a service provider that provides services by using the service providing server 60.

The charging policy extraction unit 20 identifies, based on the identification information about the communication terminal, charging policy information about the communication terminal from the charging server 40 that manages the charging policy information about a plurality of communication terminals. The charging server 40 manages each communication terminal and applied charging policy information in such a manner that they are associated with each other. Accordingly, the charging policy extraction unit 20 can identify the charging policy set to the communication terminal, by using the identification information about the communication terminal.

The charging policy control unit 30 updates the charging policy applied to the communication terminal so that the charging policy currently applied is changed to a charging policy sent from the service providing server 60.

As described above, the gateway device 1 shown in FIG. 1 is a device that relays a communication between the mobile communication network and the service providing server 60 located in the external communication network. Accordingly, the gateway device 1 receives the charging policy change request signal from the service providing server 60, and accesses the charging server 40 located in the mobile communication network, thereby making it possible to change the charging policy managed by the charging server 40.

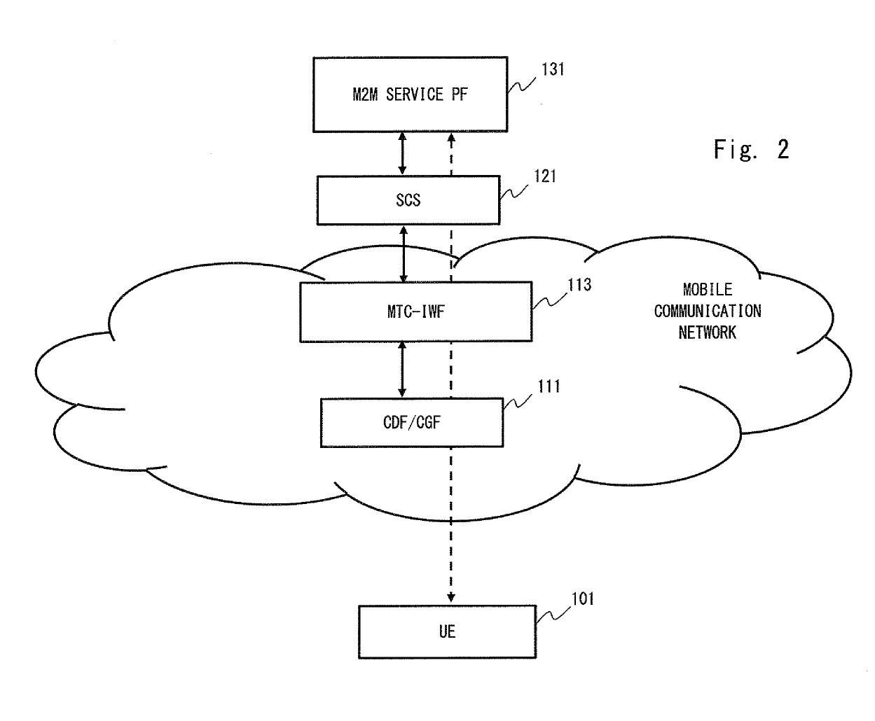

Next, a detailed configuration example of the mobile communication system according to the first exemplary embodiment of the present invention will be described with reference to FIG. 2. The mobile communication system shown in FIG. 2 is configured using devices specified in 3GPP technical specifications. The mobile communication system shown in FIG. 2 includes a UE (User Equipment) 101, a CDF/CGF 111, an MTC (Machine Type Communication)-IWF (Inter Working Function) 113, an SCS (Service Capability Server) 121, and an M2M service PF 131.

The UE 101 described herein refers to equipment used in 3GPP technical specifications, the UE being a general term for mobile communication terminals. The CDF (Charging Data Function)/CGF (Charging Gateway Function) 111 corresponds to the charging server 40 shown in FIG. 1. The MTC-IWF 113 and SCS 121 correspond to the gateway device 1 shown in FIG. 1. The M2M service PF 131 corresponds to the service providing server 60 shown in FIG. 1.

The UE 101 may be, for example, a portable telephone terminal, a smartphone terminal, a laptop personal computer, or mobile means having a communication function installed in an automobile, a train, or the like, or a device having a communication function installed in a machine, such as a watch, which is worn by the user. Alternatively, the UE 101 may be a device, which is rarely moved and controlled via a wireless communication line, such as a vending machine having a communication function installed therein. The UE 101 communicates with the M2M service PF 131 via the mobile communication network. In the case where the services provided by the M2M service PF 131 are used, the UE 101 transmits an event notification to the M2M service PF 131.

The CDF/CGF 111 manages charging policies for each UE. For example, when a session between the UE 101 and the M2M service PF 131 is started, a charging process is started using the charging policy corresponding to the UE 101. When the session between the UE 101 and the M2M service PF 131 is terminated, the CDF/CGF 111 generates charge information and transmits the generated charge information to another device that processes the charge information to, for example, create a charge bill.

The M2M service PF 131 is located in an external communication network different from the mobile communication network. The M2M service PF 131 may be composed of one server device, or may be composed of a plurality of server devices which operate in cooperation with each other. The M2M service PF 131 notifies the SCS 121 of the charging policy change request signal. The charging policy change request signal includes identification information about the UE 101 which has transmitted the event notification, and information about the charging policy to be applied to the UE 101.

Examples of the services provided by the M2M service PF 131 include provision of online games and provision of advertisement information. Alternatively, the M2M service PF 131 may provide the service of collecting sensor information detected by a sensor function installed in the UE 101 and releasing the result of an analysis of the sensor information to the public.

The SCS 121 is located between the MTC-IWF 113 and the M2M service PF 131, and, for example, converts control data, user information, and the like into a form that can be read by each device. For example, upon receiving the charging policy change request signal from the M2M service PF 131, the SCS 121 may notify the MTC-IWF 113 of the IMSI of the UE, to which a charging policy change is applied, or an identifier, such as MSISDN. FIG. 2 illustrates the configuration in which the SCS 121 is located in the external communication network, but the SCS 121 may instead be located in the mobile communication network. In other words, the SCS 121 is configured to communicate with devices located in the external communication network and devices located in the mobile communication network.

The MTC-IWF 113 relays a communication between the SCS 121 and the CDF/CGF 111. That is, the MTC-IWF 113 and the SCS 121 operate in cooperation with each other, so that the MTC-IWF 113 and the SCS 121 serve as a gateway to the M2M service PF 131 located in the external communication network. The MTC-IWF 113 receives, from the SCS 121, a Device Trigger Request which indicates a request for changing the charging policy. Further, upon receiving the Device Trigger Request, the MTC-IWF 113 designates a target UE and notifies the CDF/CGF 111 of the change of the charging policy.

In this case, the MTC-IWF 113 may execute an authentication process as to whether or not the M2M service PF 131 is the M2M service PF that is allowed in advance to change the charging policy in the CDF/CGF 111. The MTC-IWF 113 may manage information about a list of M2M service PFs which are allowed in advance to execute a process for changing the charging policy. The MTC-IWF 113 may execute the authentication process for the M2M service PF 131 by determining whether or not the identification information about the M2M service PF 131, which is transmitted together with the Device Trigger Request, is included in the list of managed transmission destinations.

The CDF/CGF 111 changes the charging policy of the target UE according to a charging policy change instruction sent from the MTC-IWF 113.

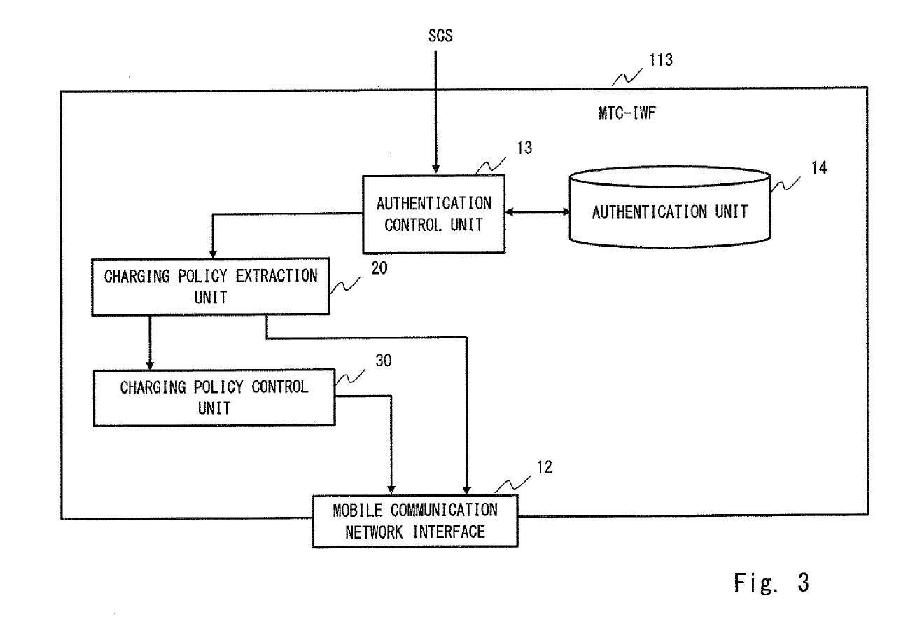

Next, a configuration example of the MTC-IWF 113 according to the first exemplary embodiment of the present invention will be described with reference to FIG. 3. The MTC-IWF 113 includes a mobile communication network interface 12, an authentication control unit 13, an authentication unit 14, the charging policy extraction unit 20, and the charging policy control unit 30.

The authentication control unit 13 uses the authentication unit 14 to determine whether or not to execute the process associated with the charging policy change request signal transmitted from the M2M service PF 131. The authentication unit 14 stores a list of identification information pieces about the M2M service PFs which are allowed in advance to execute the charging policy change process. The authentication control unit 13 determines whether or not the identification information about the M2M service PF 131 is stored in the authentication unit 14. When the authentication control unit 13 determines that the M2M service PF 131 is allowed in advance to execute the charging policy change process, the authentication control unit 13 notifies the charging policy extraction unit 20 that the M2M service PF 131 is the M2M service PF which is allowed in advance to execute this process.

The charging policy extraction unit 20 extracts the charging policy of the UE, for which the charging policy is to be changed, from the CDF/CGF 111 via the mobile communication network interface 12. Further, the charging policy extraction unit 20 outputs the extracted charging policy and the changed charging policy sent from the M2M service PF 131 to the charging policy control unit 30 via the SCS 121.

The charging policy control unit 30 transmits an instruction signal, which indicates an instruction to change the charging policy of the target UE to the charging policy sent from the M2M service PF 131, to the CDF/CGF 111 via the mobile communication network interface 12. Further, when the charging policy extracted by the charging policy extraction unit 20 is different from the charging policy sent from the M2M service PF 131, the charging policy control unit 30 may transmit the instruction signal to change the charging policy.

The mobile communication network interface 12 is used to communicate with node devices in the mobile communication network, such as SGW (Serving GW), PGW (PDN GW), and the CDF/CGF 111.

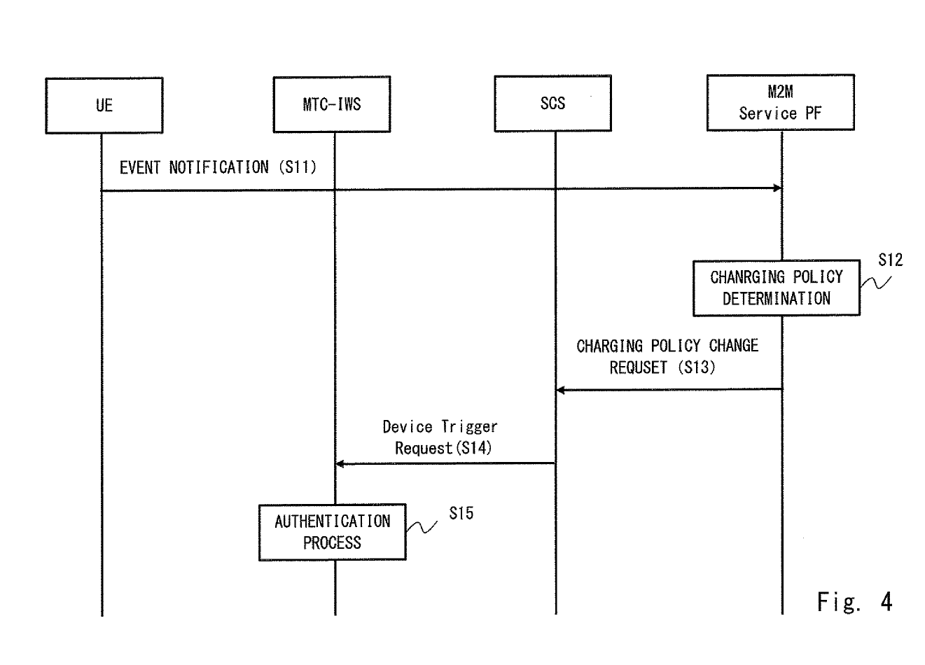

Next, a flow of a process for transmitting the charging policy change request signal according to the first exemplary embodiment of the present invention will be described with reference to FIG. 4. First, to receive the services provided by the M2M service PF 131, the UE 101 transmits an event notification to the M2M service PF 131 (S11). For example, to participate in an online game provided by the M2M service PF 131, the UE 101 may transmit an event notification to the M2M service PF 131.

Next, the M2M service PF 131 determines the charging policy of the UE 101 (S12). The M2M service PF 131 determines the charging policy to the effect that when the UE 101 participates in an online game, for example, communication charges to be incurred in the mobile communication network are charged to the M2M service PF 131.

Next, the M2M service PF 131 transmits, to the SCS 121, a charging policy change request for the UE 101 (S13). Next, the SCS 121 transmits, to the MTC-IWF 113, a Device Trigger Request signal including identification information about the M2M service PF 131, identification information about the UE 101, for which the charging policy is to be changed, and charging policy information determined by the M2M service PF 131 (S14).

Next, the MTC-IWF 113 determines whether the M2M service PF 131 is the M2M service PF allowed in advance as the M2M service PF that changes the charging policy in the CDF/CGF 111 (S15).

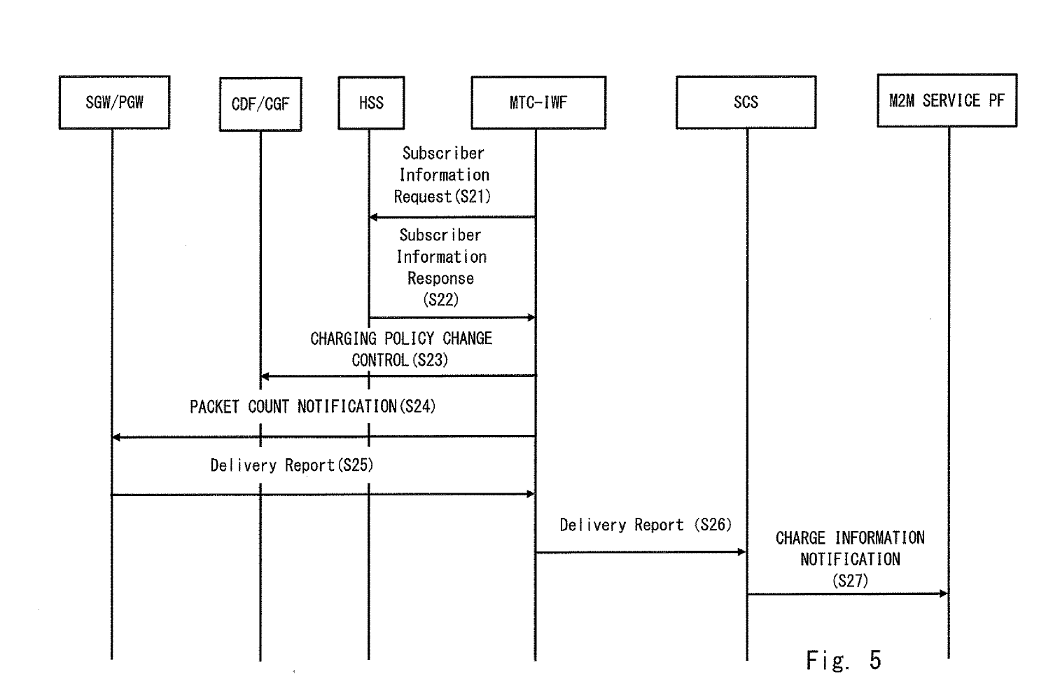

Referring next to FIG. 5, a flow of a process performed after the M2M service PF 131 is authenticated as the M2M service PF that can change the charging policy will be described. The MTC-IWF 113 transmits a Subscriber Information Request to an HSS so as to identify the CDF/CGF 111 that manages the charging policy of the UE 101 for which the charging policy is to be changed (S21). The HSS is a node device specified in 3GPP technical specifications, and holds subscriber information about the UE, information about an MME that manages the UE, and the like. The Subscriber Information Request includes MSISDN, SCS ID, or the like as identification information about the UE 101.

Next, the HSS transmits a Subscriber Information Response to the MTC-IWF 113 (S22). The Subscriber Information Response is a response signal corresponding to the Subscriber Information Request, and is used to notify the MTC-IWF 113 of the identification information about the CDF/CGF 111 that manages the charging policy of the UE 101.

Next, the MTC-IWF 113 performs a control to change the charging policy of the UE 101 that is managed by the CDF/CGF 111 sent from the HSS (S23). Specifically, the MTC-IWF 113 controls the charging policy of the UE 101, which is set by the mobile communication carrier, to be changed to the charging policy sent from the M2M service PF 131.

Next, the MTC-IWF 113 notifies the SGW and PGW, which are located in the mobile communication network, about counting of the number of packets, for example, after the charging policy is changed (S24). The SGW and the PGW relay user data between the UE 101 and the M2M service PF 131. In steps S21 and S22, the MTC-IWF 113 may acquire information about the SGW and PGW which send and receive user packets to and from the UE 101. Alternatively, in steps S21 and S22, the MTC-IWF 113 may identify the MME that manages the movement of the UE 101, and may acquire, from the MME, information about the SGW and PGW which send and receive user packets to and from the UE 101.

Next, the SGW and PGW count the number of packets, which are transmitted by their own devices, set the counting results in a Delivery Report, and notify the MTC-IWF 113 of the Delivery Report (S25). The SGW and PGW may count the number of packets separately before and after the change of the charging policy. In this case, the SGW and PGW may count the number of packets for each bearer set in the UE 101, or may count the number of packets for each APN associated with the M2M service PF 131. Alternatively, the SGW and PGW may count the number of packets for each IP address of the M2M service PF 131 or the UE 101. Instead of counting the number of packets, the SGW and PGW may count the period of time during which the UE 101 is connected to the mobile communication network, that is, the period of time during which resources are allocated to the UE 101.

Next, the MTC-IWF 113 generates information (CDR Information) about the charge bill based on such information as the number of packets transmitted from the SGW and PGW to the SCS 121, and transmits the CDR Information to the SCS 121 by using the Delivery Report (S26).

Next, the SCS 121 notifies the M2M service PF 131 of the charge information on the session between the UE 101 and the M2M service PF 131 (S27).

As described above, the use of the mobile communication system according to the first exemplary embodiment of the present invention enables the SCS 121 to receive the request for changing the charging policy sent from the M2M service PF 131 managed by a third party. Furthermore, the use of the SCS 121 and the MTC-IWF 113 makes it possible to change the charging policy of the CDF/CGF 111 located in the mobile communication network.

### Second Exemplary Embodiment

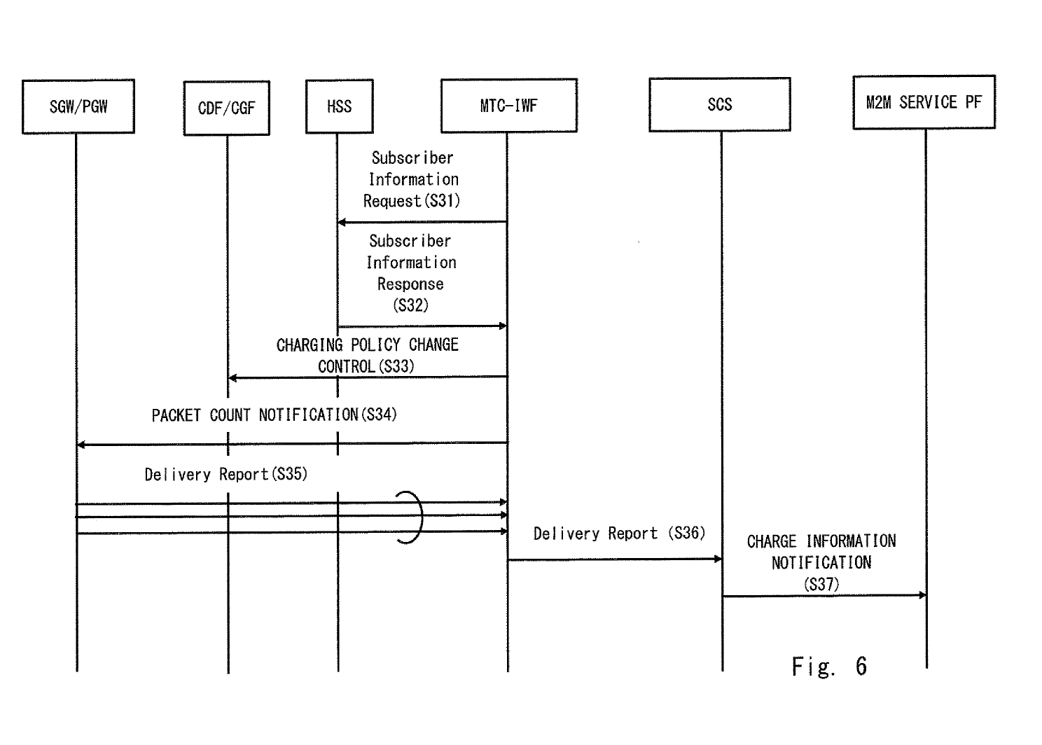

Referring next to FIG. 6, a flow of a process performed after the M2M service PF 131 according to a second exemplary embodiment of the present invention is authenticated as the M2M service PF that can change the charging policy will be described. FIG. 6 illustrates a case where the M2M service PF 131 collects sensor information in a plurality of UEs.

Steps S31 to S34 shown in FIG. 6 are the same as steps S21 to S24 shown in FIG. 5, and thus the detailed description thereof is omitted. However, since the M2M service PF 131 communicates with a plurality of UEs, in step S33, the control is performed so as to change the charging policy for each UE with which the M2M service PF 131 communicates.

In step S35, the SGW and PGW count the number of packets, which are transmitted by their own devices, set the counting results in the Delivery Report, and notify the MTC-IWF 113 of the Delivery Report (S35). In this case, the M2M service PF 131 communicates with a plurality of UEs so as to collect sensor information from the plurality of UEs. Accordingly, the MTC-IWF 113 receives the Delivery Report from a plurality of SGWs and PGWs.

Next, the MTC-IWF 113 generates one Delivery Report by combining a plurality of Delivery Reports, and transmits the generated Delivery Report to the SCS 121. In other words, instead of transmitting a plurality of Delivery Reports, one of which is generated for each UE, to the SCS 121, the MTC-IWF 113 generates one Delivery Report by adding the numbers of packets counted in each Delivery Report. The SCS 121 then notifies the M2M service PF 131 of the charge information based on the generated one Delivery Report.

As described above, the use of the mobile communication system according to the second exemplary embodiment of the present invention enables the MTC-IWF 113 to generate one Delivery Report by combining a plurality of Delivery Reports. Accordingly, it is not necessary for the SCS 121 to notify the M2M service PF 131 of a plurality of pieces of charge information. This leads to a simplification of the charging process and a reduction in the amount of communication between the SCS 121 and the M2M service PF 131.

In general, communication charges incurred during transmission of packets in the mobile communication network are charged to each UE subscribing to the mobile communication carrier. On the other hand, the use of the mobile communication system according to the second exemplary embodiment of the present invention makes it possible to change the charging policy by using the MTC-IWF 113 and SCS 121 so that communication charges are charged to the M2M service PF 131 which has used the UEs each serving as a sensor terminal.

### Another Exemplary Embodiment

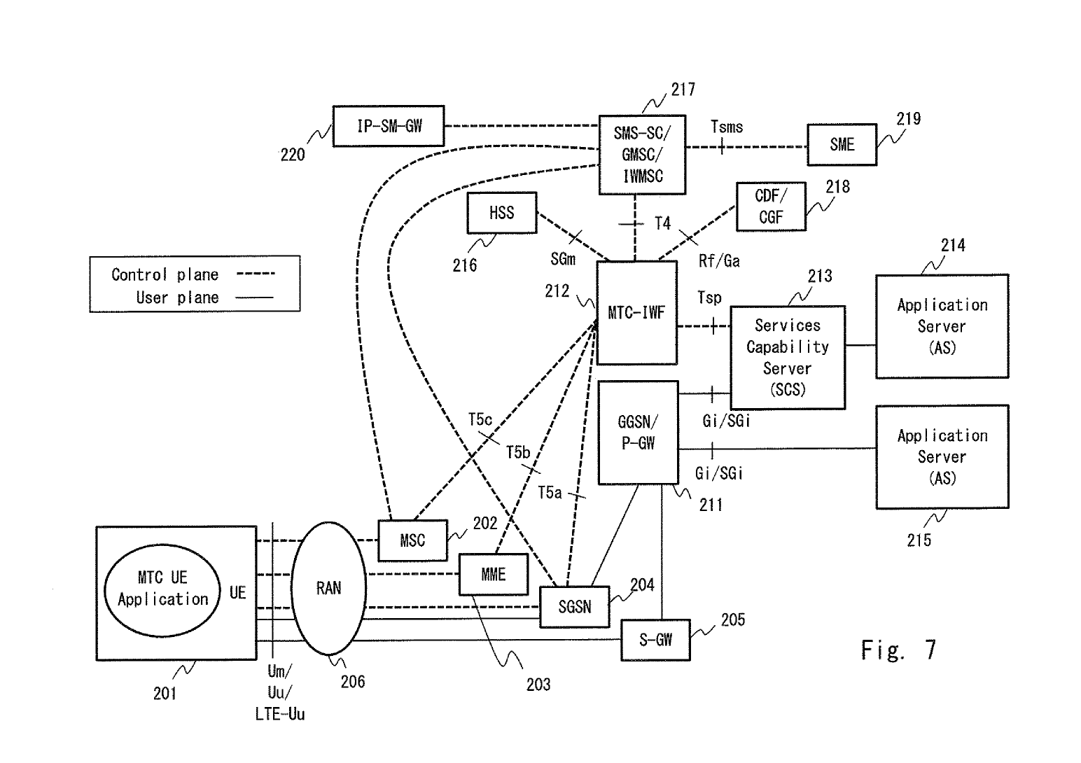

Referring to FIG. 7, a network system in which the MTC-IWF 113 and the SCS 121 according to the first to third exemplary embodiments described above are applied to the network specified in 3GPP technical specifications will be described.

The network system shown in FIG. 7 includes a UE (User Equipment) 201, a RAN (Radio Access Network) 206, an MSC (Mobile Switching Center) 202, an MME 203, an SGSN (Serving GPRS Support Node) 204, an S-GW 205, a GGSN (Gateway GPRS Support Node)/P-GW 211, an MTC-IWF 212, an SCS 213, ASs (Application Servers) 214 and 215, an HSS 216, an SMS-SC (Short Message Service-Service Center)/GSM® SC/IWMSC 217, a CDF (Charging Data Function)/CGF (Charging Gateway Function) 218, an SME (Short Message Entity) 219, and an IP-SM-GW 220.

The MTC-IWF 212 and SCS 213 are located so as to relay a communication between the MSC 202, MME 203, and SGSN 204, and the AS 214. In this case, the AS 214 is located in an external communication network different from the mobile communication network. The MTC-IWF 212 is located in the mobile communication network. The SCS 213 may be located in either the mobile communication network or the external communication network. In other words, the position where the SCS 213 is located depends on the network design policies of the communication carrier, the AS carrier, and the like.

The present invention is described as a hardware configuration in the exemplary embodiments described above, but the present invention is not limited thereto. According to the present invention, the processes in the MTC-IWF 113 can also be implemented by causing a CPU (Central Processing Unit) to execute a computer program.

In the above-mentioned example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line, such as electric wires and optical fibers, or a wireless communication line.

Note that the present invention is not limited to the exemplary embodiments described above, and can be modified in various manners without departing from the scope of the invention. For example, the charging policy may be determined in such a manner that communication charges for service contents provided by the M2M service PF 131 are reduced, for example, when a relatively long transmission delay is allowed, or when the allocated communication bandwidth is narrow.

While the present invention has been described above with reference to exemplary embodiments, the present invention is not limited to the above exemplary embodiments. The configuration and details of the present invention can be modified in various manners which can be understood by those skilled in the art within the scope of the invention.

This application is based upon and claims the benefit of priority from Japanese patent application No. 2012-101828, filed on Apr. 26, 2012, the disclosure of which is incorporated herein in its entirety by reference.

### REFERENCE SIGNS LIST

1 GATEWAY DEVICE
10 SIGNAL RECEPTION UNIT
12 MOBILE COMMUNICATION NETWORK INTERFACE
13 AUTHENTICATION CONTROL UNIT
14 AUTHENTICATION UNIT
20 CHARGING POLICY EXTRACTION UNIT
30 CHARGING POLICY CONTROL UNIT
40 CHARGING SERVER
50 NODE DEVICE
60 SERVICE PROVIDING SERVER
101 UE
111 CDF/CGF
113 MTC-IWF
121 SCS
131 M2M SERVICE PF

1. A mobile communication system comprising:
a node device located in a mobile communication network;
a service providing server located in an external communication network different from the mobile communication network; and
a gateway device that relays a data communication between the node device and the service providing server, wherein
the gateway device includes:
a signal reception unit that receives a charging policy change request signal from the service providing server, the charging policy change request signal including: identification information about a first communication terminal that performs communication via the mobile communication network; and a charging policy change request for requesting to change a first charging policy applied to the first communication terminal to a second charging policy determined in the service providing server;
a charging policy extraction unit that identifies, based on the identification information about the first communication terminal, charging policy information about the first communication terminal from a charging server that manages charging policy information about a plurality of communication terminals; and
a charging policy control unit that changes a charging policy applied to the first communication terminal from the first charging policy to the second charging policy.

2. The mobile communication system according to claim 1, wherein when the charging policy applied to the first communication terminal is changed from the first charging policy to the second charging policy, the node device manages the number of transmitted packets separately before and after the change of the charging policy.

3. The mobile communication system according to claim 2, wherein when the service providing server communicates with a plurality of communication terminals, the gateway device totalizes the number of transmitted packets which are counted for each of the communication terminals and sent from the node device, and notifies the service providing server of charge information generated based on the total number of transmitted packets.

4. The mobile communication system according to claim 1, wherein when the charging policy applied to the first communication terminal is changed from the first charging policy to the second charging policy, the node device manages connect times for the first communication terminal to connect to the mobile communication network, separately before and after the change of the charging policy.

5. The mobile communication system according to claim 4, wherein when the service providing server communicates with a plurality of communication terminals, the gateway device totalizes the connect times which are counted for each of the communication terminals and sent from the node device, and notifies the service providing server of charge information generated based on the total connect time.

6. The mobile communication system according to claim 1, wherein the gateway device identifies a charging server that manages charge information about the first communication terminal based on identification information about the first communication terminal, the identification information being included in the charging policy change request signal transmitted from the service providing server.

7. The mobile communication system according to claim 1, wherein upon receiving the charging policy change request signal, the gateway device performs an authentication process related to the service providing server and determines whether or not to change the charging policy in the first communication terminal.

8. The mobile communication system according to claim 1, wherein the charging policy change request signal includes the charging policy change request for requesting to change the first charging policy to the second charging policy, the first charging policy specifying that communication charges incurred by a packet transmission occurring in the mobile communication network are charged to the first communication terminal, the second charging policy specifying that the communication charges are charged to the service providing server.

9. A gateway device that relays a data communication between a node device located in a mobile communication network and a service providing server located in an external communication network different from the mobile communication network, the gateway device comprising:
a signal reception unit that receives a charging policy change request signal from the service providing server, the charging policy change request signal including: identification information about a first communication terminal that performs communication via the mobile communication network; and a charging policy change request for requesting to change a first charging policy applied to the first communication terminal to a second charging policy determined in the service providing server;
a charging policy extraction unit that identifies, based on the identification information about the first communication terminal, charging policy information about the first communication terminal from a charging server that manages charging policy information about a plurality of communication terminals; and
a charging policy control unit that changes a charging policy applied to the first communication terminal from the first charging policy to the second charging policy.

10. The gateway device according to claim 9, wherein the charging policy extraction unit identifies a charging server that manages charge information about the first communication terminal based on the identification information about the first communication terminal included in the charging policy change request signal transmitted from the service providing server.

11. The gateway device according to claim 9, wherein upon receiving the charging policy change request signal, the charging policy extraction unit performs an authentication process related to the service providing server and determines whether or not to change the charging policy in the first communication terminal.

12. A charging policy control method in a gateway device that relays a data communication between a node device located in a mobile communication network and a service providing server located in an external communication network different from the mobile communication network, the charging policy control method comprising:
receiving, from the service providing server, a charging policy change request signal including: identification information about a first communication terminal that performs communication via the mobile communication network; and a charging policy change request for requesting to change a first charging policy applied to the first communication terminal to a second charging policy determined in the service providing server;
identifying, based on the identification information about the first communication terminal, charging policy information about the first communication terminal from a charging server that manages charging policy information about a plurality of communication terminals; and
changing a charging policy applied to the first communication terminal from the first charging policy to the second charging policy.

13. A non-transitory computer readable medium storing a program, the program causing a computer in a gateway device that relays a data communication between a node device located in a mobile communication network and a service providing server located in an external communication network different from the mobile communication network, to execute the steps of:
receiving, from the service providing server, a charging policy change request signal including: identification information about a first communication terminal that performs communication via the mobile communication network; and a charging policy change request for requesting to change a first charging policy applied to the first communication terminal to a second charging policy determined in the service providing server;
identifying, based on the identification information about the first communication terminal, charging policy information about the first communication terminal from a charging server that manages charging policy information about a plurality of communication terminals; and
changing a charging policy applied to the first communication terminal from the first charging policy to the second charging policy.
